(19) United States
(12) Patent Application Publication
(10) Pub. No.: US 2026/0032757 A1
(43) Pub. Date: Jan. 29, 2026

(54) VOICE CALL PERFORMANCE OPTIMIZATION FOR A MULTI SIM/eSIM WIRELESS DEVICE

(71) Applicant: Apple Inc., Cupertino, CA (US)

(72) Inventors: Riteshkumar S. PATEL, Pleasanton, CA (US); Tushar K. PATEL, Milpitas, CA (US)

(21) Appl. No.: 19/261,486

(22) Filed: Jul. 7, 2025

Related U.S. Application Data
(60) Provisional application No. 63/674,615, filed on Jul. 23, 2024.

(51) Int. Cl. H04W 76/27; H04L 65/1016; H04W 8/20; H04W 60/04; H04W 68/02

(52) U.S. Cl. CPC H04W 76/27; H04L 65/1016; H04W 8/20; H04W 60/04; H04W 68/02

(57) ABSTRACT

The described embodiments relate to wireless communications, including methods and apparatus for optimizing voice call performance of a device that includes multiple subscriber identity modules (SIMs) and/or electronic SIMs (eSIMs) during select scenarios. A multi-SIM/eSIM wireless device can include at least two SIM/eSIM profiles that each provide access to cellular wireless services; however, baseband resources of the multi-SIM/eSIM wireless device can be allocated to only one SIM/eSIM at a time. The multi-SIM/eSIM wireless device limits a time duration that a single SIM/eSIM can be allocated the baseband resources to allow another SIM/eSIM access to the baseband resources to initiate or receive a voice call.

### CROSS-REFERENCE TO RELATED APPLICATIONS

The present application claims the benefit of U.S. Provisional Application No. 63/674,615, entitled “VOICE CALL PERFORMANCE OPTIMIZATION FOR A MULTI SIM/eSIM WIRELESS DEVICE,” filed Jul. 23, 2024, the content of which is incorporated by reference herein in its entirety for all purposes.

### FIELD

The described embodiments relate to wireless communications, including methods and apparatus for optimizing voice call performance of a device that includes multiple subscriber identity modules (SIMs) and/or electronic SIMs (eSIMs) during select scenarios. A multi-SIM/eSIM wireless device can include at least two SIM/eSIM profiles that each provide access to cellular wireless services; however, baseband resources of the multi-SIM/eSIM wireless device can be allocated to only one SIM/eSIM at a time. The multi-SIM/eSIM wireless device limits a time duration that a single SIM/eSIM can be allocated the baseband resources to allow another SIM/eSIM access to the baseband resources to initiate or receive a voice call.

### BACKGROUND

Fifth generation (5G) cellular wireless networks that implement one or more 3^{rd} Generation Partnership Project (3GPP) standards have been deployed by mobile network operators (MNOs). In addition, sixth generation (6G) standards are in active development. Cellular wireless networks can provide a range of packet-based services, with 5G (and 6G) technology providing increased data throughput and lower latency connections that enable enhanced mobile broadband services for 5G-capable (and 6G-capable) wireless devices. Access to cellular services provided by an MNO can be achieved through use of cellular credentials and/or secure processing provided by a secure element (SE), such as a universal integrated circuit card (UICC), an embedded UICC (eUICC), or an integrated UICC (iUICC) included in the wireless device.

In some implementations, wireless devices have been configured to use removable UICCs, or physical subscriber identity module (pSIM) cards, that include at least a microprocessor and a read-only memory (ROM), where the ROM is configured to store an MNO profile, also referred to as a subscriber identity module (SIM) or a SIM profile, which the wireless device can use to register and interact with an MNO to obtain wireless services via a cellular wireless network. The SIM profile hosts subscriber data, such as a digital identity and one or more cryptographic keys, to allow the wireless device to communicate with a cellular wireless network. The SIM profile hosts subscriber data, such as a digital identity and one or more cryptographic keys, to allow the wireless device to communicate with a cellular wireless network. In other implementations, UICCs can be embedded into system boards of wireless devices as eUICCs or integrated with other system components as iUICCs. A wireless device can also include an embedded secure element (eSE) processor that can be used for secure transactions, such as for banking, credit cards, public transportation, etc. The eUICCs and/or iUICCs can include a non-volatile rewritable memory that can facilitate installation, modification, and/or deletion of one or more electronic SIMs (eSIMs) on the eUICC/iUICC, where the eSIMs can provide for new and/or different services and/or updates for accessing extended features provided by MNOs. The use of multiple SIMs and/or eSIMs is expected to offer flexibility for access to multiple services of multiple wireless networks.

A multi-SIM/eSIM wireless device can register for access to wireless services of one or more cellular wireless networks using two or more different SIMs/eSIMs in parallel. The wireless circuitry of the multi-SIM/eSIM wireless device can limit configuration of a cellular wireless modem in the multi-SIM/eSIM wireless device to allow only one SIM/eSIM to be allocated baseband resources for active communication with a cellular wireless network at one time. There exists a need to dynamically manage access to baseband resources of a multi-SIM/eSIM wireless device under various circumstances to provide adequate voice call performance.

### SUMMARY

The described embodiments relate to wireless communications, including methods and apparatus for optimizing voice call performance of a device that includes multiple subscriber identity modules (SIMs) and/or electronic SIMs (eSIMs) during select scenarios. A multi-SIM/eSIM wireless device can include at least two SIM/eSIM profiles that each provide access to cellular wireless services. The multi-SIM/eSIM wireless device can register for access to wireless services of one or more cellular wireless networks using two or more different SIMs/eSIMs in parallel. The wireless circuitry of the multi-SIM/eSIM wireless device can limit configuration of a cellular wireless modem of the multi-SIM/eSIM wireless device to allow only one SIM/eSIM to be allocated baseband resources for active communication with a cellular wireless network at one time. Baseband circuitry of the multi-SIM/eSIM wireless device can include cellular software stacks for multiple SIMs/eSIMs and a baseband arbitration module to manage access to baseband resources for the software stacks of the different SIMs/eSIMs of the multi-SIM/eSIM wireless device. A cellular software stack for a first SIM/eSIM, associated with a first cellular wireless network, can transition a radio resource control (RRC) status for the first SIM/eSIM from an RRC connected state to an RRC idle state locally at the multi-SIM wireless device, while a second SIM/eSIM is actively used for data transmission with a second cellular wireless network. In some cases, the first and second cellular wireless networks are the same, while in other cases, the first and second cellular wireless networks are different. The local RRC state of the first SIM/eSIM maintained at the multi-SIM/eSIM wireless device can be unsynchronized with a corresponding RRC state maintained by the first cellular wireless network. The multi-SIM/eSIM wireless device limits a time duration that the second SIM/eSIM can be allocated the baseband resources for active data transmission by initiating a voice call monitor timer for the first SIM/eSIM while in the RRC idle state. If the second SIM/eSIM releases the baseband resources before expiration of the voice call monitor timer, the voice call monitor can be stopped and reset. If the second SIM/eSIM continues to be allocated the baseband resources and the voice call monitor timer expires, the baseband arbitration module can initiate a device-to-network status update procedure to allow the first SIM/eSIM access to the baseband resources, e.g., to initiate a mobile originated (MO) voice call to the first cellular wireless network or to receive a mobile terminated (MT) voice call from the first cellular wireless network. The device-to-network status update procedure can include: i) a tracking area update (TAU) procedure when the first cellular wireless network operates in accordance with a fourth generation (4G) long term evolution (LTE) wireless communication protocol, or ii) a mobility update registration procedure with the first cellular wireless network operates in accordance with a fifth generation (5G) new radio (NR) wireless communication protocol. In some embodiments, the first SIM/eSIM can be designated as a voice-preferred SIM/eSIM prioritized for voice calls for the multi-SIM/eSIM wireless device, and the second SIM/eSIM can be designated as a non-voice-preferred SIM/eSIM.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement cellular service access and provisioning for a wireless device, according to some embodiments.

FIG. 2 illustrates a block diagram of a more detailed view of exemplary components of a mobile wireless device of the system of FIG. 1, according to some embodiments.

FIG. 3A illustrates a block diagram of an exemplary dual SIM wireless device in communication with two different wireless networks, according to some embodiments.

FIG. 3B illustrates block diagrams of exemplary multi-SIM and multi-SIM/eSIM wireless devices, according to some embodiments.

FIG. 4A illustrates a block diagram of an exemplary dual SIM dual active (DSDA) wireless device, according to some embodiments.

FIG. 4B illustrates block diagrams of exemplary dual SIM dual standby (DSDS) wireless devices, according to some embodiments.

FIG. 5A illustrates a flow chart of an example of an unsynchronized RRC state impacting voice call performance for a DSDS multi-SIM/eSIM wireless device, according to some embodiments.

FIG. 5B illustrates a flow chart of an exemplary procedure to optimize voice call performance for a DSDS multi-SIM/eSIM wireless device, according to some embodiments.

FIG. 5C illustrates an exemplary set of actions to reinstate an RRC connected state between a SIM software stack of the DSDS multi-SIM/eSIM wireless device with a wireless network, according to some embodiments.

FIG. 6 illustrates a flow chart of an exemplary method for optimizing voice call performance for a DSDS multi-SIM/eSIM wireless device, according to some embodiments.

FIG. 7 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

The described embodiments relate to wireless communications, including methods and apparatus for optimizing voice call performance of a device that includes multiple subscriber identity modules (SIMs) and/or electronic SIMs (eSIMs) during select scenarios. A multi-SIM/eSIM wireless device can include at least two SIM/eSIM profiles that each provide access to cellular wireless services. In some embodiments, one SIM/eSIM, of multiple SIM/eSIMs of the multi-SIM/eSIM wireless device, can be designated as a voice-preferred SIM/eSIM prioritized for voice calls for the multi-SIM/eSIM wireless device, while other SIMs/eSIMs of the multi-SIM wireless device can be designated as non-voice-preferred. In some embodiments, the voice-preferred SIM/eSIM can be designated as a data-preferred SIM/eSIM to be used preferentially for cellular wireless data communication, while in other embodiments, a non-voice-preferred SIM/eSIM can be designated as the data-preferred SIM/eSIM for the multi-SIM/eSIM wireless device. In representative configurations, only one SIM/eSIM of multiple SIMs/eSIMs of the multi-SIM/eSIM wireless device is designated as a voice-preferred SIM and only one SIM/eSIM is designated as a data-preferred SIM, such as selected by a user of the multi-SIM/eSIM wireless device or based on a default configuration. The multi-SIM/eSIM wireless device can register for access to wireless services of one or more cellular wireless networks using two or more different SIMs/eSIMs in parallel. In some embodiments, a first SIM/eSIM designated as a voice-preferred SIM/eSIM registers with a first cellular wireless network, while a second SIM/eSIM designated as a non-voice-preferred SIM/eSIM registers with a second cellular wireless network.

The wireless circuitry of the multi-SIM/eSIM wireless device can limit configuration of a cellular wireless modem of the multi-SIM/eSIM wireless device to allow only one SIM/eSIM to be allocated baseband resources for active communication with a cellular wireless network at one time. Baseband circuitry of the multi-SIM/eSIM wireless device, such as a baseband processor, can include cellular software stacks for multiple SIMs/eSIMs and a baseband arbitration module to manage access to baseband resources for the software stacks of the different SIMs/eSIMs of the multi-SIM/eSIM wireless device. The baseband arbitration module can determine which SIM/eSIM (and its associated cellular software stack) can access baseband resources based on prioritization of uses of the baseband resources by the respective SIMs/eSIMs. The baseband arbitration module can allocate baseband resources to a second SIM/eSIM, and therefore a first SIM/eSIM can be unable to communicate with its respective associated cellular wireless networks until being allocated baseband resources. The first SIM/eSIM can monitor paging indications for mobile terminated (MT) voice calls from a first cellular wireless network while in a synchronized radio resource control (RRC) idle state with the first cellular wireless network. In some cases, however, the first SIM/eSIM can be in an unsynchronized RRC state with the first cellular wireless network and therefore unable to receive MT voice calls from the first cellular wireless network.

A cellular software stack for a first SIM/eSIM, associated with a first cellular wireless network, can transition a radio resource control (RRC) status for the first SIM/eSIM from an RRC connected state to an RRC idle state locally at the multi-SIM wireless device, while a second SIM/eSIM is allocated baseband resources and is actively used for data transmission with a second cellular wireless network. In some cases, the first and second cellular wireless networks are the same, while in other cases, the first and second cellular wireless networks are different. In some cases, the first SIM/eSIM is a voice-preferred SIM/eSIM and the second SIM/eSIM is a non-voice-preferred SIM/eSIM. The local RRC state of the first SIM/eSIM maintained at the multi-SIM/eSIM wireless device after transitioning to the RRC idle state can be unsynchronized with a corresponding RRC state maintained by the first cellular wireless network for the first SIM/eSIM of the multi-SIM/eSIM wireless device. While the second SIM/eSIM maintains active data transmission with the second cellular wireless network, baseband resources are not allocated to the first SIM/eSIM by the baseband arbitration module. The first SIM/eSIM cannot be allocated baseband resources to initiate an MO voice call for the first SIM/eSIM or to perform a procedure to synchronize the RRC status of the first SIM/eSIM with the first cellular wireless network. The first cellular wireless network can be unaware of the transition of the first SIM/eSIM to the RRC idle state, and an Internet Protocol Multimedia Subsystem (IMS) Session Internet Protocol (SIP) invite message from the first cellular wireless network, such as for an MT voice call to the first SIM/eSIM, can be missed by the multi-SIM/eSIM wireless device. As the first cellular wireless network continues to believe that the first SIM/eSIM of the multi-SIM/eSIM wireless device is in the RRC connected state, the first cellular wireless network may continue to attempt to contact the multi-SIM/SIM wireless device via an IMS SIP invite message rather than using a paging indication during a paging time slot. In some cases, the first SIM/eSIM is a voice-preferred SIM/eSIM for the multi-SIM/eSIM wireless device, and a user of the multi-SIM/eSIM wireless device can expect to send and receive cellular wireless voice calls via the first SIM/eSIM rather than via the second SIM/eSIM that has been allocated the baseband resources by the baseband arbitration module of the multi-SIM/eSIM wireless device. With a long duration time period of data activity by the second SIM/eSIM, the first SIM/eSIM can be unable to obtain baseband resources for a voice call. In some cases, the second SIM/eSIM can be designated as a data-preferred SIM/eSIM, while in other cases the second SIM/eSIM can be a non-data-preferred SIM/eSIM (e.g., not preferred for data communication or for voice calls).

To reduce time that the first SIM/eSIM is unable to access the first cellular wireless network while in the unsynchronized RRC state, the multi-SIM/eSIM wireless device can limit a time duration that the second SIM/eSIM is allocated the baseband resources for active data transmission. A baseband processor of the multi-SIM/eSIM wireless device can initiate a voice call monitor timer for the first SIM/eSIM while in the RRC idle state when the second SIM/eSIM has been allocated baseband resources for data transmission. In some cases where the second SIM/eSIM is being used for a voice call, the first voice call monitor timer is not initiated, as a voice call for the first SIM/eSIM may not be used to interrupt the voice call of the second SIM/eSIM. A voice call for the first SIM/eSIM, particularly when designated as a voice-preferred SIM/eSIM, can be preferred to interrupt data transmission (or to limit the total continuous time of data transmission) of the second SIM/eSIM. If the second SIM/eSIM releases the baseband resources before expiration of the voice call monitor timer, the voice call monitor can be stopped and reset. If the second SIM/eSIM continues to be allocated baseband resources for data transmission by the baseband arbitration module and the voice call monitor timer expires, the baseband arbitration module (or another processing module of a baseband processor) can initiate a device-to-network status update procedure between the first SIM/eSIM and the first cellular wireless network. The device-to-network status update procedure can be used to allow the first SIM/eSIM to gain access to the baseband resources of the multi-SIM/eSIM wireless device, e.g., to initiate a mobile originated (MO) voice call to the first cellular wireless network or to receive a mobile terminated (MT) voice call from the first cellular wireless network. The device-to-network status update procedure can include: i) a tracking area update (TAU) procedure when the first cellular wireless network operates in accordance with a fourth generation (4G) long term evolution (LTE) wireless communication protocol, or ii) a mobility update registration procedure with the first cellular wireless network operates in accordance with a fifth generation (5G) new radio (NR) wireless communication protocol. In some embodiments, the first SIM/eSIM can be designated as a voice-preferred SIM/eSIM prioritized over other SIMs/eSIMs for voice calls for the multi-SIM/eSIM wireless device, and the second SIM/eSIM can be designated as a non-voice-preferred SIM/eSIM, i.e., not prioritized for voice calls over other SIMs/eSIMs for the multi-SIM/eSIM wireless device.

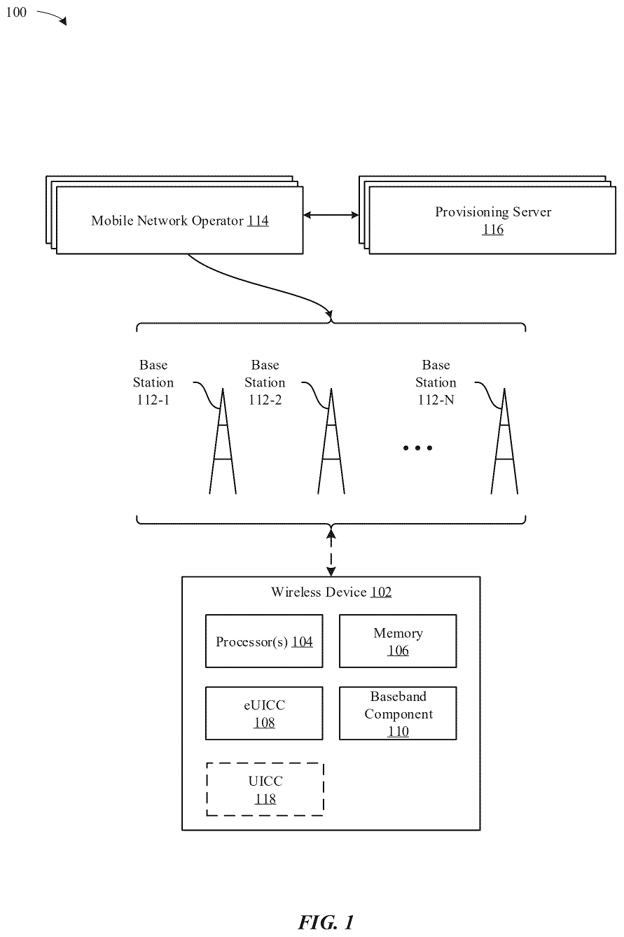

These and other embodiments are discussed below with reference to FIGS. 1 through 7; however, those skilled in the art will readily appreciate that the detailed description given herein with respect to these figures is for explanatory purposes only and should not be construed as limiting.

FIG. 1 illustrates a block diagram of different components of a system 100 that includes a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like. Further, reference to actions performed by a wireless device 102 can be construed to include actions performed by the wireless device 102 as a whole and/or one or more components (e.g., processors, modems, memory, etc.) of the wireless device 102. The system further includes a group of base stations 112-1 to 112-N, which are managed by different Mobile Network Operators (MNOs) 114. The system can further include a set of provisioning servers 116 that are in communication with the MNOs 114. The wireless device 102 can represent a mobile computing device (e.g., a phone, a tablet, a peripheral device, etc.), the base stations 112-1 to 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUs)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and baseband component 110 used for transmission and reception of cellular wireless radio frequency signals. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIM (eSIM) profiles and/or an iUICC providing one or more eSIM profiles. A wireless device 102 that includes multiple active (enabled) SIMs and/or eSIM profiles can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, baseband component 110, and UICC 118) can be arranged and combined in any number of configurations.

The eUICC 108 can be configured to store multiple eSIMs for accessing services offered by one or more different MNOs 114 via communication through base stations 112-1 to 112-N. To be able to access services provided by the MNOs, one or more eSIMs can be provisioned to the eUICC 108 of the wireless device 102. The wireless device 102 can include wireless circuitry, including the baseband component 110 and at least one transmitter/receiver, also referred to as a transceiver. In some embodiments, the wireless device 102 includes two or more transceivers. In some embodiments, the wireless device 102 can be configured to operate in a dual SIM, dual standby (DSDS) mode, with two SIMs, one SIM and one eSIM, or two eSIMs enabled and active simultaneously, but allowing active connections to only one cellular wireless network via a single, active transceiver at a time. In some embodiments, the transceiver of the wireless device 102 includes multiple receivers to allow reception of signals from multiple wireless networks and only one transmitter for transmitting signals to one of the multiple wireless networks at a time.

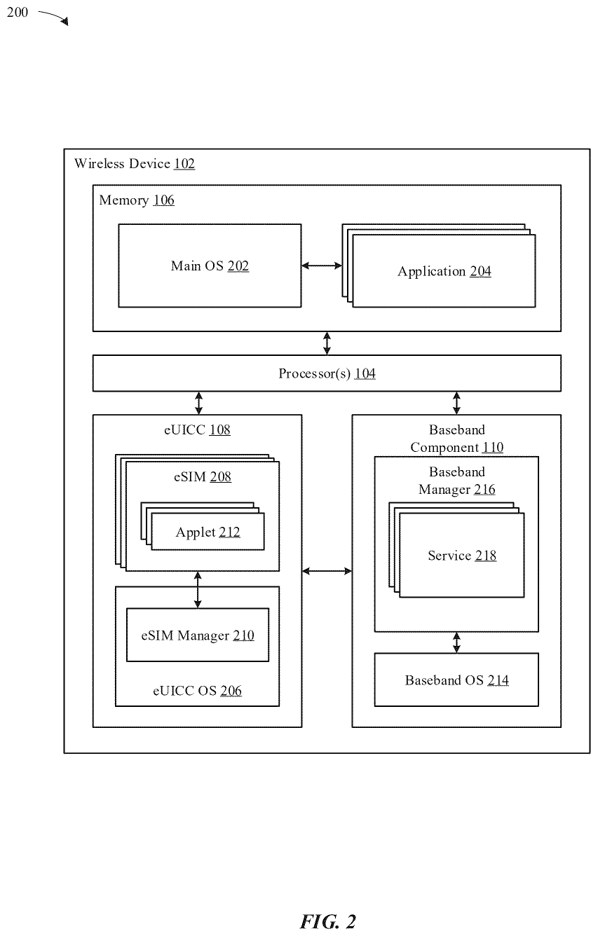

FIG. 2 illustrates a block diagram 200 of a more detailed view of exemplary components of a wireless device 102 of the system 100 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states, activity/inactivity states. The wireless device 102 further includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIMs 208 within the eUICC 108 and providing the baseband component 110 with access to the eSIMs 208 to provide access to wireless services for the wireless device 102. The eUICC OS 206 can include an eSIM manager 210, which can perform management functions for various eSIMs 208. Each eSIM 208 can include a number of applets 212 that define the manner in which the eSIM 208 operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

The baseband component 110 of the wireless device 102 can include a baseband OS 214 that is configured to manage hardware resources of the baseband component 110 (e.g., a processor, a memory, different radio components, etc.). The baseband component 110 (or a portion thereof) can also be referred to as a wireless baseband component, a baseband wireless processor, a cellular baseband component, a cellular component, and the like. According to some embodiments, the baseband component 110 can implement a baseband manager 216 that is configured to interface with the eUICC 108 to establish a secure channel with a provisioning server 116 and obtain information (such as eSIM 208 data) from the provisioning server 116 for purposes of managing eSIMs 208. The baseband manager 216 can be configured to implement services 218, which represent a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108. In some embodiments, a processor 104 of the wireless device 102 and/or the eUICC 108 can include a local profile assistance (LPA) module to assist with management of eSIM 208 profiles on the eUICC 108 of the wireless device 102.

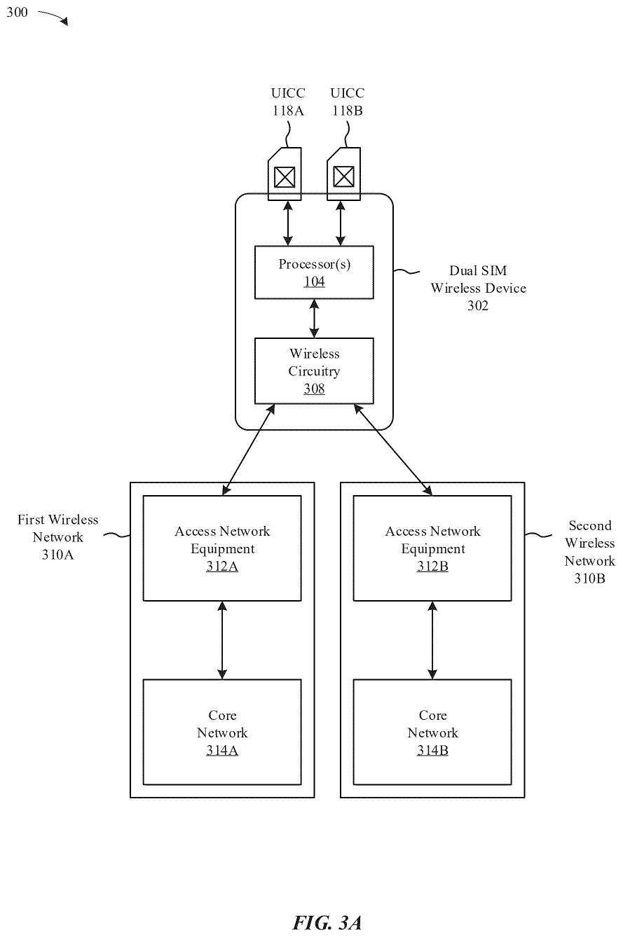

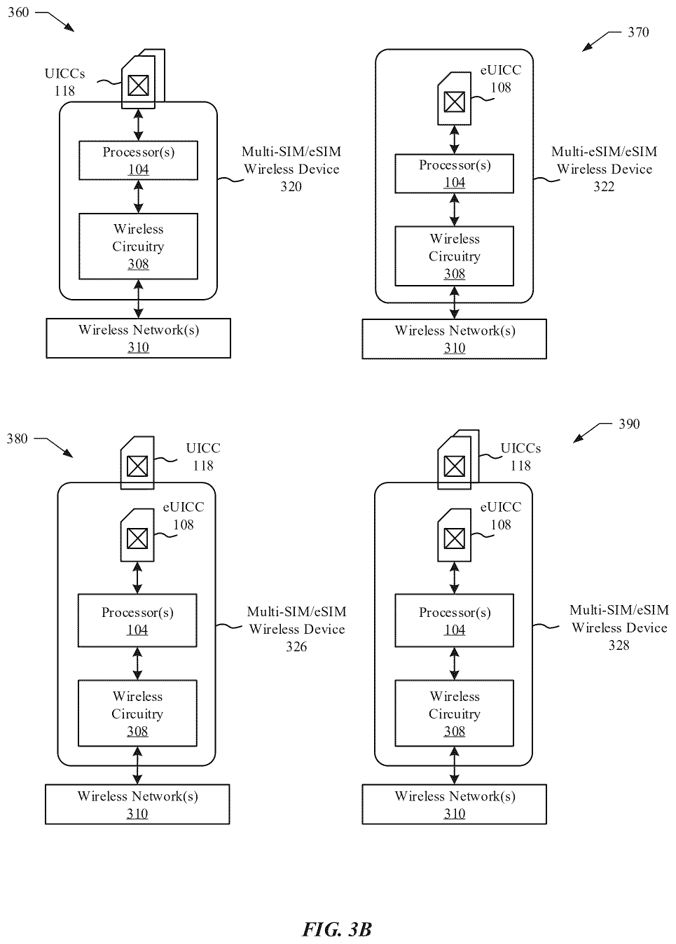

FIG. 3A illustrates a block diagram 300 of components of an exemplary dual SIM wireless device 302 including one or more processor(s) 104 and wireless circuitry 308 that provides for wireless radio frequency (RF) connections between the dual SIM wireless device 302 and a first wireless network 310A and a second wireless network 310B. In some embodiments, the wireless circuitry 308 includes one or more baseband component(s) 110, and a set of RF analog front-end circuitry. In some embodiments, the wireless circuitry 308 and/or a portion thereof can include or be referred to as a wireless transmitter/receiver or a transceiver or a radio. The terms circuit, circuitry, component, and component block may be used interchangeably herein, in some embodiments, to refer to one or more operational units of a wireless device that process and/or operate on digital signals, analog signals, or digital data units used for wireless communication. For example, representative circuits can perform various functions that convert digital data units to transmitted radio frequency analog waveforms and/or convert received analog waveforms into digital data units including intermediate analog forms and intermediate digital forms. The wireless circuitry 308 can include components of RF analog front-end circuitry, e.g., a set of one or more antennas, which can be interconnected with additional supporting RF circuitry that can include filters and other analog components that can be “configured” for transmission and/or reception of analog signals via one or more corresponding antennas to one or more of the first and second wireless networks 310A/B. The processor(s) 104 and the wireless circuitry 308 can be configured to perform and/or control performance of one or more functionalities of the dual SIM wireless device 302, in accordance with various implementations. The processor(s) 104 and the wireless circuitry 308 can provide functionality for coordinating hardware/software resources in the dual SIM wireless device 302 to improve performance for mobility management of connections to one or more of the wireless networks 310A/B.

The dual SIM wireless device 302 includes two removable UICCs 118A/B, which can be inserted and removed from the dual SIM wireless device 302 together or independently. Each UICC 118A/B includes at least one software identity module (SIM), which can be embodied as a software/firmware program installed on the UICC 118A/B. Removable UICCs 118A/B can provide a user of the dual SIM wireless device 302 the ability to replace a UICC to change services, provided the dual SIM wireless device 302 supports such flexibility (e.g., an “unlocked” device that is not “locked” to a particular wireless network operator or service provider). Hardware complexity and/or a size of a wireless device can limit the ability to include multiple UICC slots, and thus additional arrangements for wireless devices are can include multiple SIMs on a single UICC 118 and/or eSIMs 208 on an eUICC 108 or combinations thereof. The dual SIM wireless device 302, in some embodiments, can register with two different wireless networks, e.g., the first and second wireless networks 310A/B, simultaneously. The first wireless network 310A can operate in accordance with a first wireless communication protocol, e.g., a 5G NR wireless communication protocol, while the second wireless network 310B can operate with a second wireless communication protocol that can be the same as the first wireless communication protocol or a different wireless communication protocol, e.g., a 4G LTE wireless communication protocol. The first and second wireless networks 310A/B can operate using different radio frequency bands in accordance with their respective wireless communication protocols. The first and second wireless network 310A/B can operate using different radio frequency bands of a common wireless communication protocol, e.g., using an FR1 RF band and an FR2 band of a 5G NR wireless communication protocol. The wireless circuitry 308 of the dual SIM wireless device 302 can be configured to register with and/or establish a connection with the first wireless network 310A via access network equipment 312A, which interfaces with a core network 314A. The wireless circuitry 308 of the dual SIM wireless device 302 can also be configured to register with and/or establish a connection with the second wireless network 310B via access network equipment 312B, which interfaces with a core network 314B. In some embodiments, the wireless circuitry 308 of the dual SIM wireless device 302 supports transmission and reception to only one of the first and second wireless networks 310A/B at a time. In some embodiments, the wireless circuitry 308 of the dual SIM wireless device 302 supports transmission to only one of the first and second wireless networks 310A/B at a time and reception from one or both of the first and second wireless networks 310A/B. A dual SIM wireless device 302 that can connect to only one wireless network at a time, but can monitor and/or receive communication from two wireless networks with which it is registered, can be referred to as a “Dual SIM, Dual Standby” (DSDS) wireless device. A dual SIM wireless device 302 that can connect to two wireless networks simultaneously using two different subscriber identities can be referred to as a “Dual SIM, Dual Active” (DSDA) wireless device.

FIG. 3B illustrates diagrams 360, 370, 380, 390 of additional exemplary multi-SIM/eSIM wireless devices 320, 322, 326, 328 that support multiple subscriber identities using removable UICCs 118 and/or eUICCs 108 with SIMs or eSIMs 208 implemented respectively thereon. As illustrated in diagram 360, a multi-SIM/eSIM wireless device 320 includes multiple UICCs 118, which can be inserted and removed individually or together, and communicate with one or more processors 104 that connect to wireless circuitry 308 that provides for wireless communication with one or more wireless networks 310. As the physical size and design of the multi-SIM/eSIM wireless device 320 can limit the number of UICCs 118 that can be supported, alternatively as shown by diagram 370, a multi-SIM/eSIM wireless device 322 can include an eUICC 108 connected with the processor(s) 104 and to the wireless network(s) 310 via the wireless circuitry 308. The eUICC 108 can be built into the multi-SIM/eSIM wireless device 322 and can be not removable from the multi-SIM/eSIM wireless device 322, e.g., permanently affixed to a circuit board in the multi-SIM/eSIM wireless device 322. The eUICC 108 can be programmed such that one or more eSIMs 208 can be implemented on the eUICC 108. Each eSIM 208 can be associated with a distinct subscriber identity and/or provide distinct services or subscriptions for a user of the multi-SIM/eSIM wireless device 322. Diagram 380 illustrates a multi-eSIM/SIM wireless device 326 that includes a removable UICC 118, on which can be installed one or more SIMs, and an eUICC 108 on which one or more eSIMs 208 can be installed. The combination of SIMs on the UICC 118 and/or eSIMs 208 on the eUICC 108 can provide for connections to one or more wireless networks 310 using the wireless circuitry 308 under the control of the processor(s) 104 of the multi-SIM/eSIM wireless device 326. Diagram 390 illustrates another multi-eSIM/SIM wireless device 328 that includes multiple UICCs 118, on which one or more SIMs can be installed, and an eUICC 108, on which one or more eSIMs 208 can be installed. A combination of one or more SIMs on a UICC 118 and/or eSIMs on an eUICC 108 can provide for connections to one or more wireless networks 310 using the wireless circuitry 308 under the control of the processor(s) 104 of the multi-SIM/eSIM wireless device 328. In general, a wireless device 102 that supports multiple subscriber identities can include (i) at an eUICC 108 and/or (ii) one or more UICCs 118. Each UICC 118 can support one or more SIMs, and each eUICC 108 can support one or more eSIMs 208. A wireless device 102 that supports multiple subscriber identities, e.g., 302, 320, 322, 326, 328, can include a combination of SIMs and/or eSIMs 208 to support communication with one or more wireless networks 310.

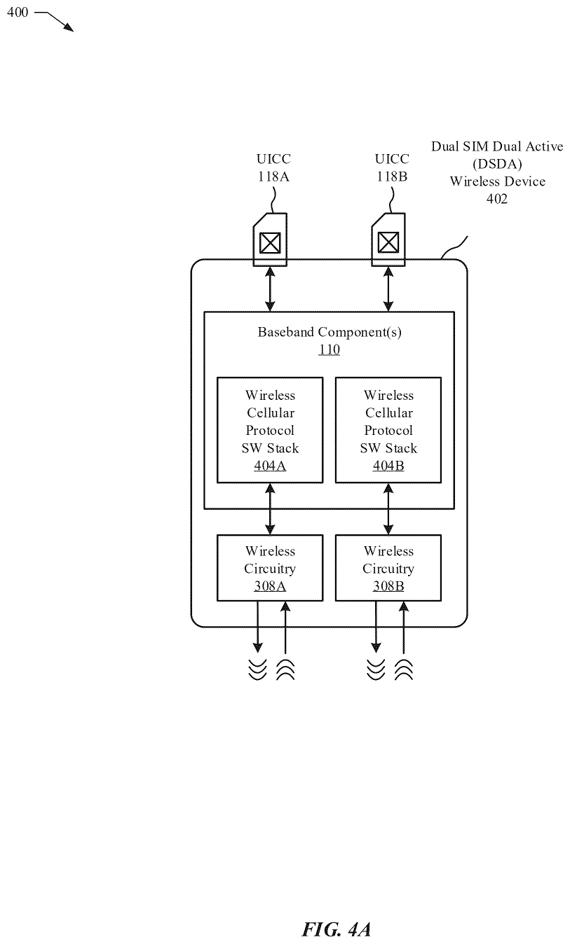

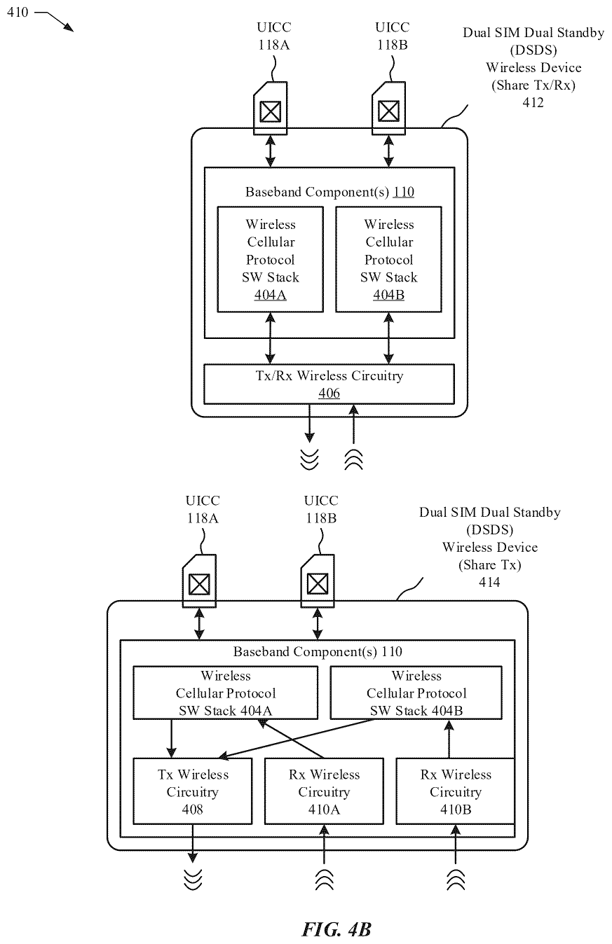

FIG. 4A illustrates a diagram 400 of a DSDA wireless device 402 that includes two removable UICCs 118A/B, on which at least two SIMs are installed, e.g., one SIM on each of the UICCs 118A/B. (While the DSDA wireless device 402 illustrated in FIG. 4A includes two UICCs 118A/B, alternative architectures for the DSDA wireless device 402 can include combinations of UICCs 118 and/or an eUICC 108 as discussed herein.) Each UICC 118A/B can communicate with one or more baseband components 110, e.g., via another processor 104 and/or directly. A first cellular wireless protocol software (SW) stack 404A on the one or more baseband component(s) 110 can communicate with a first wireless network 310A (not shown) via wireless circuitry 308A, while a second cellular wireless protocol SW stack 404B can communicate with a second wireless network 310B (not shown) via wireless circuitry 308B. With parallel wireless circuitry 308A/B, the DSDA wireless device 402 can interact with two wireless networks 310A/B independently without requiring an interface or interaction between the cellular wireless protocol SW stacks 304A/B. Each of the cellular wireless protocol SW stacks 404A/B can support communication using one or more wireless communication protocols. With sufficient parallel wireless circuitry 308A/B and parallel cellular wireless protocol SW stacks 404A/B, the DSDA wireless device 402 can be registered with two different wireless networks 310A/B and can form connections with the two different wireless networks 310A/B in parallel and independently. The DSDA wireless device 402 can receive notifications (e.g., paging messages and/or paging indications) from a second wireless network 310B while connected to a first wireless network 310A, as the parallel wireless circuitry 308A/B permits parallel, simultaneous communication to two different wireless networks 310A/B. While the DSDA wireless device 402 advantageously can communicate with multiple wireless networks 310A/B, a DSDS wireless device can require less wireless circuitry and be more cost effective and power efficient.

FIG. 4B illustrates a diagram 410 of two exemplary configurations of DSDS wireless devices 412/414. (While the DSDS wireless devices 412/414 illustrated in FIG. 4B include two UICCs 118A/B, alternative architectures for the DSDS wireless devices 412/414 can include combinations of UICCs 118 and/or an eUICC 108 as discussed herein.) A DSDS wireless device 412 includes two removable UICCs 118A/B, on which at least two SIMs are installed, and each UICC 118A/B can communicate with one or more baseband components 110, on which two cellular wireless protocol software stacks 404A/B operate. Each cellular wireless protocol software stack 404A/B can communicate with a respective wireless network 310A/B (not shown) via a set of common transmit/receive (Tx/Rx) wireless circuitry 406. In some embodiments, the set of common Tx/Rx wireless circuitry 406 provides for transmission and/or reception by one cellular wireless protocol SW stack 404A or 404B at a time, and thus the DSDS wireless device 412 can be associated with two (or more) wireless networks 310A/B at the same time but not be able to communicate with both wireless networks 310A/B simultaneously. For example, the DSDS wireless device 412 can be configured to operate in a time division mode that shares the Tx/Rx wireless circuitry 406 among the cellular wireless protocol SW stacks 404A/B. In some embodiments, the cellular wireless protocol SW stacks 404A/B can both operate in a radio resource control (RRC) idle mode and listen for paging messages from each of two different wireless networks 310A/B (e.g., alternate listening for paging messages from each wireless network 310A/B by reconfiguring if required the Tx/Rx wireless circuitry 406 to receive signals from each wireless network 310A/B.) The DSDS wireless device 412 can permit associations with two different wireless networks 310A/B using two different subscriber identities but can allow only one active connection at any time. In some cases, one cellular wireless protocol SW stack 404A can operate in a RRC connected mode with an active voice or data connection with cellular wireless network 310A, while the other cellular wireless protocol SW stack 404B can operate in an RRC idle mode with cellular wireless network 310B and listen for paging messages from 310B.

In a second configuration of a DSDS wireless device 414, a shared set of wireless circuitry 408/410A/B provides for one transmit path and two parallel receive paths that can be used simultaneously. Each cellular wireless protocol software stack 404A/B can be configured to transmit via a set of transmit (Tx) wireless circuitry 408, but only one cellular wireless protocol software stack 404A/B can communicate at any one time via the Tx wireless circuitry 408. Both cellular wireless protocol software stacks 404A/B can receive radio frequency wireless signals via respective receive (Rx) wireless circuitry 410A/B in parallel. The DSDS wireless device 414 can share transmit wireless circuitry 408 between two cellular wireless protocol SW stacks 404A/B, while permitting simultaneous reception via dedicated (and/or configurable) receive wireless circuitry 410A/B. The DSDS wireless device 414 can provide for a connection (e.g., bi-directional data and/or signaling communication) with only one wireless network at a time; however, paging messages (or other control signaling) can be received (e.g., in a downlink direction) from two wireless networks 310A/B at the same time. Similarly, the parallel Rx wireless circuitry 410A/B can provide for reception of broadcast channels, signaling channels, synchronization channels, or other signals from two parallel wireless networks, e.g., for measurements of cells, as part of reselection and/or handover processes, when searching for wireless networks with which to establish connections, to perform downlink (DL) synchronization processes, and/or for associating or registering with wireless networks, etc. The DSDS wireless device 414 can be connected to a first wireless network 310A, e.g., in a voice call, data connection, video call, or other bi-directional connection with the first wireless network 310A, and advantageously can receive paging messages from a second wireless network 310B at the same time. However, if the cellular wireless protocol SW stack 404A of the DSDS wireless device 414 is connected to the first wireless network 310A with an active data connection, the other cellular wireless protocol SW stack 404B of the DSDS wireless device 414, while in a local RRC idle state that is not synchronized with a remote RRC idle state maintained by the second wireless network 310B, can be unable to receive a mobile terminated (MT) voice call from the second wireless network 310B, which can try to contact the DSDS wireless device 414 via an Internet Protocol Multimedia Subsystem (IMS) Session Initiation Protocol (SIP) invite message (applicable for an RRC connected state) rather than via a paging indication message (applicable for an RRC idle state).

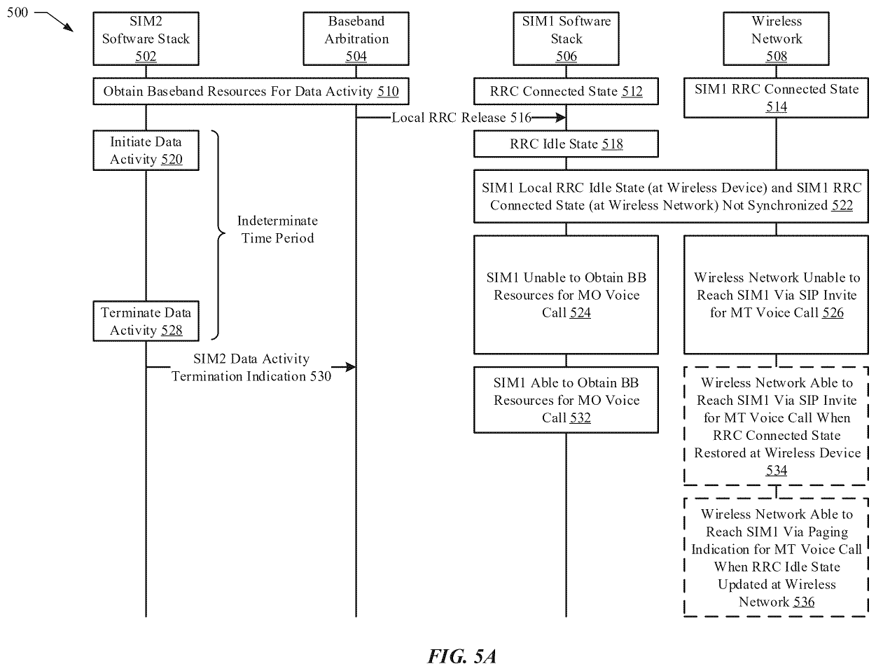

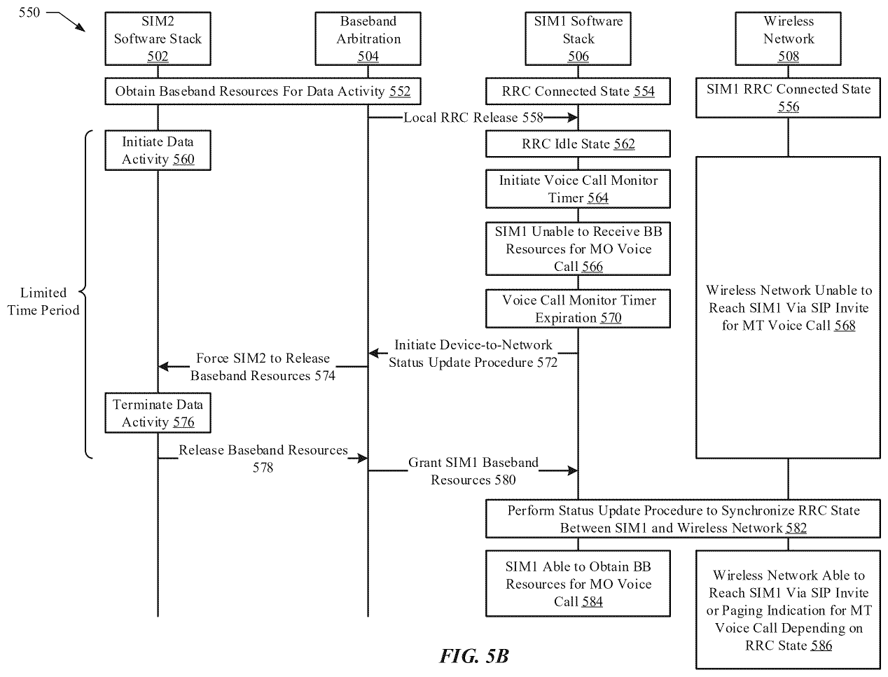

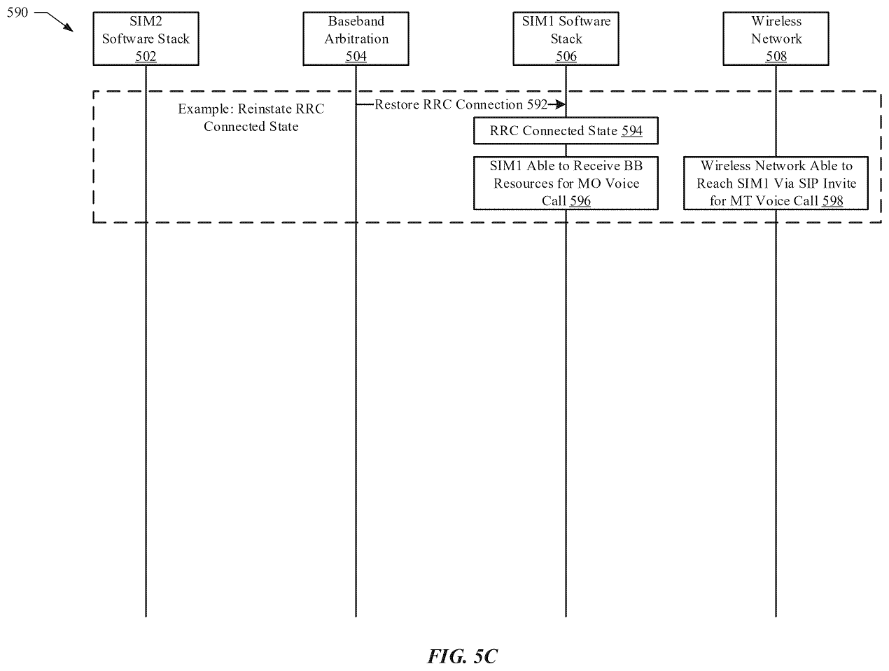

FIG. 5A illustrates a flow chart 500 of an example of an unsynchronized RRC state impacting voice call performance for a DSDS multi-SIM/eSIM wireless device. At 510, a second software stack for a second SIM (SIM2) 502 of the DSDS multi-SIM/eSIM wireless device can obtain from a baseband arbitration module 504 of the DSDS multi-SIM/eSIM wireless device baseband resources for data activity, e.g., for active data communication with a first cellular wireless network. In some embodiments, at 512, when the SIM2 software stack 502 obtains the baseband resources, a first software stack for a first SIM (SIM1) 506 can be in an RRC connected state with a (second cellular) wireless network 508. The wireless network 508 can maintain an RRC state for SIM1, and at 514, the wireless network 508 can maintain an RRC connected state for SIM1. The baseband arbitration module 504 of the DSDS multi-SIM/eSIM wireless device can instruct a local RRC release 516 to cause the SIM1 software stack 506 to transition, locally at the DSDS multi-SIM/eSIM wireless device, from the RRC connected state 512 to the RRC idle state at 518. The local RRC release of the SIM1 software stack 506 from the RRC connected state to the RRC idle state for SIM1 can be responsive to allocation of baseband resources for data activity by the baseband arbitration module 504 to the SIM2 software stack 502. The SIM2 software stack 502 can initiate data activity with a second wireless network at 520 and maintain the data activity with the second wireless network for an indeterminate time period. As such, the SIM1 software stack 506 can be unable to access baseband resources of the DSDS multi-SIM/eSIM wireless device while the SIM2 software stack 502 is allocated the baseband resources for its data activity with the second wireless network. In some cases, at 522, the SIM1 local RRC idle state at the DSDS multi-SIM/eSIM wireless device is not synchronized with a corresponding SIM1 RRC connected state at the wireless network 508. While the SIM2 software stack 502 is allocated baseband resources for data activity, the SIM1 software stack 506, at 524, is unable to obtain baseband resources for a mobile originated (MO) voice call via SIM1. Because the RRC state of SIM1 is unsynchronized between the DSDS multi-SIM/eSIM wireless device and the wireless network 508, at 526, the wireless network 508 can be unable to reach SIM1 via an IMS SIP invite message for a mobile terminated (MT) voice call. At 530, the SIM2 software stack 502 can provide to the baseband arbitration module 504 an indication that data activity for SIM2 has terminated. After the SIM2 software stack 502 no longer requires baseband resources for data activity, the SIM1 software stack 506, at 532, can obtain baseband resources from the baseband arbitration module 504, e.g., to initiate a MO voice call. In some embodiments, the RRC state of SIM1 can be updated at the DSDS multi-SIM/eSIM wireless device to an RRC connected state and the wireless network 508, at 534, can reach SIM1 via an IMS SIP invite message for an MT voice call. In some embodiments, the RRC state of SIM1 maintained at the wireless network 508 can be updated to an RRC idle state and the wireless network 508, at 536, can reach SIM1 via a paging indication message for an MT voice call. As shown in FIG. 5A, the RRC state of SIM1 needs to be re-synchronized with the wireless network 508 in order for MO or MT voice calls via SIM1 to be available to the DSDS multi-SIM/eSIM wireless device. With continuous data activity by SIM2 for an indeterminate time period, e.g., between 520 and 528, the DSDS multi-SIM/eSIM wireless device can be unable to use SIM1 for an extended. In some cases, SIM1 can be designated as a voice-preferred SIM/eSIM and therefore preferred by a user of the DSDS multi-SIM/eSIM wireless device for voice calls. Disallowing access to baseband resources for SIM1 because of data activity of SIM2 reduces voice call performance for the DSDS multi-SIM/eSIM wireless device. As shown next, the time for which a single SIM/eSIM can be allocated the baseband resources of the DSDS multi-SIM/eSIM wireless device can be limited to allow another SIM/eSIM, such as a voice-preferred SIM/eSIM, to have access to the baseband resources for an MO or MT voice call.

FIG. 5B illustrates a flow chart 550 of an exemplary procedure to optimized voice call performance for a DSDS multi-SIM/eSIM wireless device. At 552, a second software stack for a second SIM (SIM2) 502 of the DSDS multi-SIM/eSIM wireless device can obtain from a baseband arbitration module 504 of the DSDS multi-SIM/eSIM wireless device baseband resources for data activity, e.g., for active data communication with a first cellular wireless network. In some embodiments, at 554, when the SIM2 software stack 502 obtains the baseband resources, a first software stack for a first SIM (SIM1) 506 can be in an RRC connected state with a (second cellular) wireless network 508. The wireless network 508 can maintain an RRC state for SIM1, and at 556, the wireless network 508 can maintain an RRC connected state for SIM1. The baseband arbitration module 504 of the DSDS multi-SIM/eSIM wireless device can instruct a local RRC release 558 to cause the SIM1 software stack 506 to transition, locally at the DSDS multi-SIM/eSIM wireless device, from the RRC connected state 554 to the RRC idle state at 562. The local RRC release of the SIM1 software stack 506 from the RRC connected state to the RRC idle state for SIM1 can be responsive to allocation of baseband resources for data activity by the baseband arbitration module 504 to the SIM2 software stack 502. The SIM2 software stack 502 can initiate data activity with a second wireless network at 560 and maintain the data activity with the second wireless network for a limited time period. The SIM1 software stack 506 can be unable to access baseband resources of the DSDS multi-SIM/eSIM wireless device while the SIM2 software stack 502 is allocated the baseband resources for its data activity with the second wireless network. In some cases, at 522, the SIM1 local RRC idle state at the DSDS multi-SIM/eSIM wireless device is not synchronized with a corresponding SIM1 RRC connected state at the wireless network 508. Because the RRC state of SIM1 is unsynchronized between the DSDS multi-SIM/eSIM wireless device and the wireless network 508, at 568, the wireless network 508 can be unable to reach SIM1 via an IMS SIP invite message for a mobile terminated (MT) voice call.

In some embodiments, responsive to transitioning the SIM1 software stack 506 from the RRC connected state 554 to the RRC idle state 562 while the SIM2 software stack 502 is allocated baseband resources form the baseband arbitration module 504 for data activity, the SIM1 software stack 506 (or another module of a baseband processor of the multi-SIM/eSIM wireless device) can initiate a voice call monitor timer at 564. At 566, while the SIM2 software stack 502 is allocated baseband resources for data activity, the SIM1 software stack 506 is unable to obtain baseband resources for a mobile originated (MO) voice call via SIM1. At 570 the voice call monitor timer can expire while data activity for the SIM2 software stack 502 continues to use baseband resources allocated by the baseband arbitration module 504. Responsive to expiration of the voice call monitor timer, the SIM1 software stack 506 (or another module resident on the baseband processor) can initiate a device-to-network status update procedure at 572, which can cause the baseband arbitration module 504 at 574 to force the SIM2 software stack 502 to release the baseband resources. At 576 the SIM2 software stack 502 can terminate data activity 576 and provide an indication at 578 that the SIM2 software stack releases the allocated baseband resources (or no longer requires or will stop use of baseband resources). At 580, the baseband arbitration module 504 can grant baseband resources to the SIM1 software stack 506. In some embodiments, the SIM1 software stack 506 requests baseband resources from the baseband arbitration module 504 to obtain granted SIM1 baseband resources 580. At 582, the SIM1 software stack 506 can perform a status update procedure with the wireless network 508 to synchronize the RRC state of SIM1 between the multi-SIM/eSIM wireless device and the wireless network 508. At 586, the wireless network can reach SIM1 of the multi-SIM/eSIM wireless device via an IMS SIP invite message or via a paging indication for an MT voice call, depending on whether the synchronized RRC state is an RRC idle state (in which case, the paging indication is used) or an RRC connected state (in which case, an IMS SIP invite message is used).

In some embodiments, SIM1 is designated as a voice-preferred SIM/eSIM, and the SIM1 software stack 506 can take priority for access to baseband resources from the SIM2 software stack 502 to perform the device-to-network status update procedure after expiration of the voice call monitor timer (except in some limited circumstances). In some embodiments, the device-to-network status update procedure is a tracking area update (TAU) procedure for the SIM1 software stack 506 when the wireless network 508 operates in accordance with a 4G LTE wireless communication protocol. In some embodiments, the device-to-network status update procedure is a mobility registration update procedure for the SIM1 software stack 506 when the wireless network 508 operates in accordance with a 5G NR wireless communication protocol. In some embodiments, the SIM1 software stack 506 can be restricted from interrupting an ongoing handover procedure by the SIM2 software stack 506 with a second wireless network until handover completes before accessing baseband resources to perform the device-to-network update procedure. In some embodiments, a value for the voice call monitor timer can be configurable, e.g., to equal a value substantially smaller than a corresponding time duration for the wireless network 508 to transfer an unanswered MT voice call to voice mail. For example, the voice call monitor timer can be set to five seconds, when the wireless network 508 transfers to voice mail unanswered voice calls after 10 or 20 seconds.

FIG. 5C illustrates an exemplary set of actions to reinstate an RRC connected state for the SIM1 software stack 506 with the wireless network 508. These actions can be performed as part of the device-to-network status update procedure at 582 to synchronize the RRC state between the SIM1 software stack 506 and the wireless network 508. At 592, the baseband arbitration module 504 prompts the SIM1 software stack 506 to restore the RRC connection state, i.e., to return from the temporary RRC idle state, which initiated at 562 responsive to the local RRC release at 558, to the RRC connected state at 594. As a result of the RRC connection state restoration, at 594, the SIM1 software stack 506 can be in a synchronized RRC state with the wireless network 508. When the RRC states at both the SIM1 software stack 506 and the wireless network 508 are synchronized in the RRC connected state, at 596, the SIM1 software stack 506 is able to receive baseband resources from the baseband arbitration module 504 to originate an MO voice call, and similarly at 598, the wireless network 508 is able to reach the SIM1 software stack 506 via an IMS SIP Invite message to initiate an MT voice call.

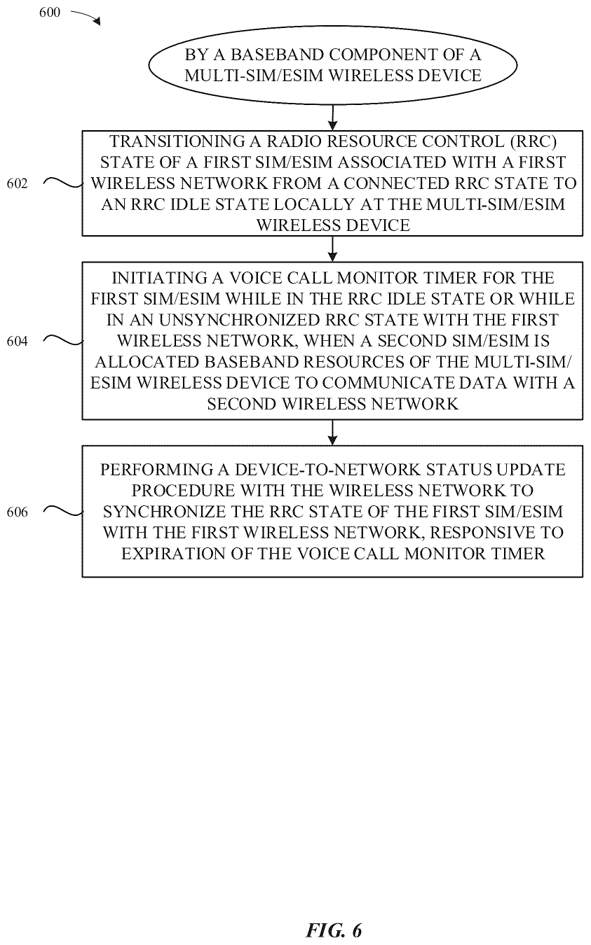

FIG. 6 illustrates a flow chart 600 of an exemplary method for a baseband component of a multi-SIM/eSIM wireless device to manage access to baseband resources for one or more SIMs and/or eSIMs 208 of a multi-SIM/eSIM wireless device to communicate with one or more wireless networks. At 602, the baseband component of the multi-SIM/eSIM wireless device transitions an RRC state of a first SIM/eSIM, associated with a first wireless network, from an RRC connected state to an RRC idle state locally at the multi-SIM/eSIM wireless device. At 604, the baseband component of the multi-SIM/eSIM wireless device initiates a voice call monitor timer for the first SIM/eSIM while in the RRC idle state (or while in an unsynchronized RRC state with the first wireless network), when a second SIM/eSIM is allocated baseband resources of the multi-SIM/eSIM wireless device to communicate data with a second wireless network. At 606, the baseband component of the multi-SIM/eSIM wireless device performs a device-to-network status update procedure with the first wireless network to synchronize the RRC state of the first SIM/eSIM with the second wireless network, responsive to expiration of the voice call monitor timer, where the multi-SIM/eSIM wireless device is unable to initiate MO voice calls to or receive MT voice calls from the first wireless network while the second SIM/eSIM is allocated the baseband resources of the multi-SIM/eSIM wireless device, and the multi-SIM/eSIM wireless device is able to able to initiate MO voice calls to and receive MT voice calls from the first wireless network after performance of the device-to-network status update procedure.

In some embodiments, the first SIM/eSIM is in an RRC connected state with the first wireless network after performing the device-to-network status update procedure to synchronize with the first wireless network. In some embodiments, the first SIM/eSIM is able to receive an IMS SIP invite message from the first wireless network for the MT voice call while in the RRC connected state synchronized with the first wireless network. In some embodiments, the first SIM/eSIM is in an RRC idle state with the first wireless network after performing the device-to-network status update procedure to synchronize with the first wireless network. In some embodiments, the first SIM/eSIM is able to receive a paging indication from the first wireless network for the MT voice call while in the RRC idle state synchronized with the first wireless network. In some embodiments, the first wireless network operates in accordance with a 4G LTE wireless communication protocol, and the device-to-network status update procedure is a TAU procedure. In some embodiments, the first wireless network operates in accordance with a 5G NR wireless communication protocol, and the device-to-network status update procedure comprises a mobility update registration procedure. In some embodiments, the method performed by the baseband component of the multi-SIM/eSIM wireless device further includes monitoring RRC connection states of the first SIM/eSIM and of the second SIM/eSIM. In some embodiments, the first SIM/eSIM includes a voice-preferred SIM/eSIM prioritized for voice calls for the multi-SIM/eSIM wireless device, and the second SIM/eSIM includes a non-voice-preferred SIM/eSIM. In some embodiments, the first SIM/eSIM is unable to initiate an MO voice call to the first wireless network while the first SIM/eSIM is in an RRC state unsynchronized with the first wireless network. In some embodiments, the first SIM/eSIM is unable to receive an MT voice call from the first wireless network while the first SIM/eSIM is in an RRC state unsynchronized with the first wireless network.

### Representative Exemplary Apparatus

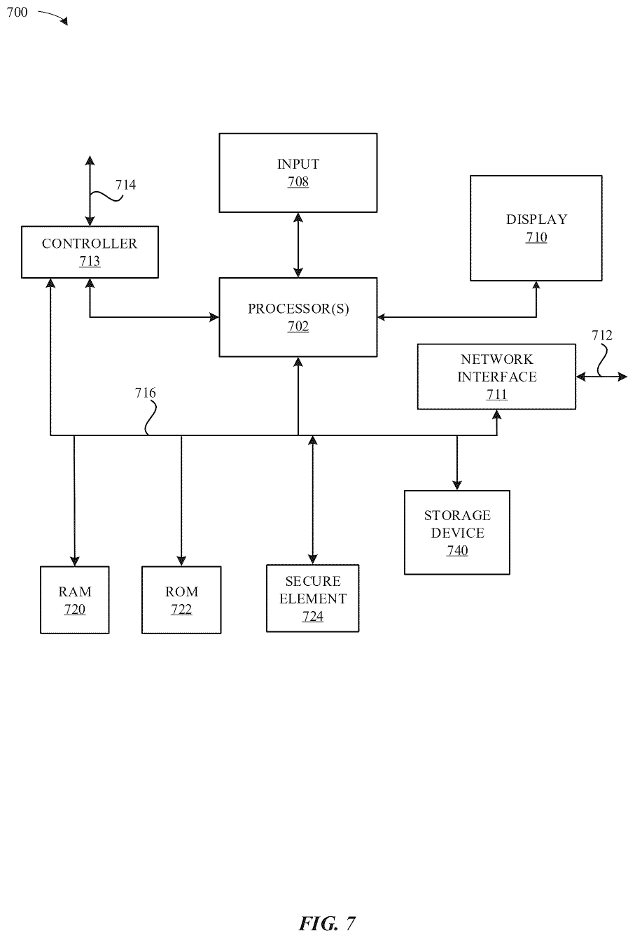

FIG. 7 illustrates in block diagram format an exemplary computing device 700 that can be used to implement the various components and techniques described herein, according to some embodiments. In particular, the detailed view of the exemplary computing device 700 illustrates various components that can be included in the wireless device 102. As shown in FIG. 7, the computing device 700 can include one or more processors 702 that represent microprocessors or controllers for controlling the overall operation of computing device 700. In some embodiments, the computing device 700 can also include a user input device 708 that allows a user of the computing device 700 to interact with the computing device 700. For example, in some embodiments, the user input device 708 can take a variety of forms, such as a button, keypad, dial, touch screen, audio input interface, visual/image capture input interface, input in the form of sensor data, etc. In some embodiments, the computing device 700 can include a display 710 (screen display) that can be controlled by the processor(s) 702 to display information to the user (for example, information relating to incoming, outgoing, or active communication sessions). A data bus 716 can facilitate data transfer between at least a storage device 740, the processor(s) 702, and a controller 713. The controller 713 can be used to interface with and control different equipment through an equipment control bus 714. The computing device 700 can also include a network/bus interface 711 that couples to a data link 712. In the case of a wireless connection, the network/bus interface 711 can include wireless circuitry, such as a wireless transceiver and/or baseband component. The computing device 700 can also include a secure element 724. The secure element 724 can include an eUICC 108 and/or one or more UICCs 118.

The computing device 700 also includes a storage device 740, which can include a single storage or a plurality of storages (e.g., hard drives and/or solid-state drives), and includes a storage management module that manages one or more partitions within the storage device 740. In some embodiments, storage device 740 can include flash memory, semiconductor (solid state) memory or the like. The computing device 700 can also include a Random-Access Memory (RAM) 720 and a Read-Only Memory (ROM) 722. The ROM 722 can store programs, utilities or processes to be executed in a non-volatile manner. The RAM 720 can provide volatile data storage, and stores instructions related to the operation of the computing device 700.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near-field communication (NFC), a cellular wireless network, a fourth generation (4G) LTE, LTE Advanced (LTE-A), 5G, and/or 6G or other present or future developed advanced cellular wireless networks.

The wireless device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode user equipment (UE) can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE network or a 3G legacy network, e.g., an Evolved High Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method to manage access to baseband resources for one or more subscriber identity modules (SIMs) and/or electronic SIMs (eSIMs) of a multi-SIM/eSIM wireless device to communicate with one or more wireless networks, the method comprising:
transitioning a radio resource control (RRC) state of a first SIM/eSIM, associated with a first wireless network, from an RRC connected state to an RRC idle state locally at the multi-SIM/eSIM wireless device;
initiating a voice call monitor timer for the first SIM/eSIM while in the RRC idle state or while in an unsynchronized RRC state with the first wireless network, when a second SIM/eSIM is allocated baseband resources of the multi-SIM/eSIM wireless device to communicate data with a second wireless network; and
performing a device-to-network status update procedure with the first wireless network to synchronize the RRC state of the first SIM/eSIM with the second wireless network, responsive to expiration of the voice call monitor timer,
wherein:
the multi-SIM/eSIM wireless device is unable to initiate mobile originated (MO) voice calls to or receive mobile terminated (MT) voice calls from the first wireless network while the second SIM/eSIM is allocated the baseband resources of the multi-SIM/eSIM wireless device; and
the multi-SIM/eSIM wireless device is able to able to initiate MO voice calls to and receive MT voice calls from the first wireless network after performance of the device-to-network status update procedure.

2. The method of claim 1, wherein:
the first SIM/eSIM is in an RRC connected state with the first wireless network after performing the device-to-network status update procedure to synchronize with the first wireless network.

3. The method of claim 2, wherein:
the first SIM/eSIM is able to receive an Internet Protocol Multimedia Subsystem (IMS) Session Internet Protocol (SIP) invite message from the first wireless network for the MT voice call while in the RRC connected state synchronized with the first wireless network.

4. The method of claim 1, wherein:
the first SIM/eSIM is in an RRC idle state with the first wireless network after performing the device-to-network status update procedure to synchronize with the first wireless network.

5. The method of claim 4, wherein:
the first SIM/eSIM is able to receive a paging indication from the first wireless network for the MT voice call while in the RRC idle state synchronized with the first wireless network.

6. The method of claim 1, wherein:
the first wireless network operates in accordance with a fourth generation (4G) long term evolution (LTE) wireless communication protocol; and
the device-to-network status update procedure comprises a tracking area update (TAU) procedure.

7. The method of claim 1, wherein:
the first wireless network operates in accordance with a fifth generation (5G) new radio (NR) wireless communication protocol; and
the device-to-network status update procedure comprises a mobility update registration procedure.

8. The method of claim 1, further comprising:
monitoring RRC connection states of the first SIM/eSIM and of the second SIM/eSIM.

9. The method of claim 1, wherein:
the first SIM/eSIM comprises a voice-preferred SIM/eSIM prioritized for voice calls for the multi-SIM/eSIM wireless device; and
the second SIM/eSIM comprises a non-voice-preferred SIM/eSIM.

10. The method of claim 1, wherein:
the first SIM/eSIM is unable to initiate an MO voice call to the first wireless network while the first SIM/eSIM is in an RRC state unsynchronized with the first wireless network.

11. The method of claim 1, wherein:
the first SIM/eSIM is unable to receive an MT voice call from the first wireless network while the first SIM/eSIM is in an RRC state unsynchronized with the first wireless network.

12. A multiple subscriber identity (SIM)/electronic SIM (eSIM) wireless device configured to manage access to baseband resources for one or more SIMs and/or eSIMs to communicate with one or more wireless networks, the multi-SIM/eSIM wireless device comprising:
a first SIM/eSIM;
a second SIM/eSIM; and
and a baseband component configured to:
transition a radio resource control (RRC) state of a first SIM/eSIM, associated with a first wireless network, from a radio resource control (RRC) connected state to an RRC idle state locally at the multi-SIM/eSIM wireless device;
initiate a voice call monitor timer for the first SIM/eSIM while in the RRC idle state or while in an unsynchronized RRC state with the first wireless network, when a second SIM/eSIM is allocated baseband resources of the multi-SIM/eSIM wireless device to communicate data with a second wireless network; and
perform a device-to-network status update procedure with the first wireless network to synchronize the RRC state of the first SIM/eSIM with the second wireless network, responsive to expiration of the voice call monitor timer,
wherein:
the multi-SIM/eSIM wireless device is unable to initiate mobile originated (MO) voice calls to or receive mobile terminated (MT) voice calls from the first wireless network while the second SIM/eSIM is allocated the baseband resources of the multi-SIM/eSIM wireless device; and
the multi-SIM/eSIM wireless device is able to able to initiate MO voice calls to and receive MT voice calls from the first wireless network after performance of the device-to-network status update procedure.

13. The multi-SIM/eSIM wireless device of claim 12, wherein:
the first SIM/eSIM is in an RRC connected state with the first wireless network after performing the device-to-network status update procedure to synchronize with the first wireless network; and
the first SIM/eSIM is able to receive an Internet Protocol Multimedia Subsystem (IMS) Session Internet Protocol (SIP) invite message from the first wireless network for the MT voice call while in the RRC connected state synchronized with the first wireless network.

14. The multi-SIM/eSIM wireless device of claim 12, wherein:
the first SIM/eSIM is in an RRC idle state with the first wireless network after performing the device-to-network status update procedure to synchronize with the first wireless network, and
the first SIM/eSIM is able to receive a paging indication from the first wireless network for the MT voice call while in the RRC idle state synchronized with the first wireless network.

15. The multi-SIM/eSIM wireless device of claim 12, wherein:
the first wireless network operates in accordance with a fourth generation (4G) long term evolution (LTE) wireless communication protocol; and
the device-to-network status update procedure comprises a tracking area update (TAU) procedure.

16. The multi-SIM/eSIM wireless device of claim 12, wherein:
the first wireless network operates in accordance with a fifth generation (5G) new radio (NR) wireless communication protocol; and
the device-to-network status update procedure comprises a mobility update registration procedure.

17. The multi-SIM/eSIM wireless device of claim 12, wherein:
the first SIM/eSIM comprises a voice-preferred SIM/eSIM prioritized for voice calls for the multi-SIM/eSIM wireless device; and
the second SIM/eSIM comprises a non-voice-preferred SIM/eSIM.

18. The multi-SIM/eSIM wireless device of claim 12, wherein:
the first SIM/eSIM is unable to initiate an MO voice call to the first wireless network while the first SIM/eSIM is in an unsynchronized RRC state with the first wireless network.

19. The multi-SIM/eSIM wireless device of claim 12, wherein:
the first SIM/eSIM is unable to receive an MT voice call from the first wireless network while the first SIM/eSIM is in an unsynchronized RRC state with the first wireless network.

20. A non-transitory computer-readable medium storing instructions for managing access to baseband resources for one or more subscriber identity modules (SIMs) and/or electronic SIMs (eSIMs) of a multi-SIM/eSIM wireless device to communicate with one or more wireless networks, the instructions comprising:
instructions for transitioning a radio resource control (RRC) state of a first SIM/eSIM, associated with a first wireless network, from a radio resource control (RRC) connected state to an RRC idle state locally at the multi-SIM/eSIM wireless device;
instructions for initiating a voice call monitor timer for the first SIM/eSIM while in the RRC idle state or while in an unsynchronized RRC state with the first wireless network, when a second SIM/eSIM is allocated baseband resources of the multi-SIM/eSIM wireless device to communicate data with a second wireless network; and
instructions for performing a device-to-network status update procedure with the first wireless network to synchronize the RRC state of the first SIM/eSIM with the second wireless network, responsive to expiration of the voice call monitor timer,
wherein:
the multi-SIM/eSIM wireless device is unable to initiate mobile originated (MO) voice calls to or receive mobile terminated (MT) voice calls from the first wireless network while the second SIM/eSIM is allocated the baseband resources of the multi-SIM/eSIM wireless device; and
the multi-SIM/eSIM wireless device is able to able to initiate MO voice calls to and receive MT voice calls from the first wireless network after performance of the device-to-network status update procedure.
